(19) United States
(12) Patent Application Publication
(10) Pub. No.: US 2014/0108962 A1
(43) Pub. Date: Apr. 17, 2014

(54) SYSTEM AND METHOD FOR PRESENTING INFORMATION RELATED TO AN ENTITY IN A VIRTUAL SPACE

(71) Applicant: Evgeny Olomskiy, Vladivostok (RU)

(72) Inventor: Evgeny Olomskiy, Vladivostok (RU)

(21) Appl. No.: 13/654,136

(22) Filed: Oct. 17, 2012

(51) Int. Cl. G06F 3/01

(52) U.S. Cl. 715/753

(57) ABSTRACT

The disclosure relates to a system and method to present information related to entities in a virtual space. In some implementations, the system may include one or more servers, one or more client computing platforms, and/or other components. The system may be configured to provide a virtual space to users. The system may be configured such that the users participate in one or more games, activities, and/or applications within a virtual space. By virtue of using the system, users may have the ability to hover (e.g., via a control icon such a mouse pointer) over an entity in the virtual space that represents another user such that the system presents an offered set of interaction identifiers associated with the other user. This may enhance the online experience for participating users. Providing the virtual space may include hosting the virtual space over a network.

### FIELD

The disclosure relates to a system and method to present information related to entities in a virtual space.

### BACKGROUND

Virtual spaces that enable users to participate in games and/or other online (social) activities are known. Virtual spaces that enable users to play games, including card games and/or other turn-based games, are known. Virtual spaces that present views of avatars to represent users are known. Animations of avatars, for example to depict action, and/or an event within a virtual space, are known. Virtual spaces that enable users to chat with each other during game play are known.

### SUMMARY

One aspect of the disclosure relates to a system to present information related to entities in a virtual space. In some implementations, the system may include one or more servers, one or more client computing platforms, and/or other components. The system may be configured to provide a virtual space to users. The system may be configured such that the users participate in one or more games, activities, and/or applications within a virtual space. By virtue of using the system, users may have the ability to hover (e.g., via a control icon such a mouse pointer) over an entity in the virtual space that represents another user such that the system presents an offered set of interaction identifiers associated with the other user. This may enhance the online experience for participating users. Providing the virtual space may include hosting the virtual space over a network.

The server may be configured to communicate with the client computing platforms according to client/server architecture. The users may access the system, a virtual game space, and/or other virtual spaces via the client computing platforms. The server may be configured to execute one or more computer program modules. The computer program modules may include one or more of a virtual space module, a user module, a hover module, an interaction presentation module, and/or other modules.

The virtual space module may be configured to provide one or more virtual spaces to users via the client computing platforms. As used herein, a “virtual space” may include one or more interactive, electronic social media, and/or other virtual environments. A virtual space may refer to a virtual environment in which a game is being played that involves a plurality of users. Providing a virtual environment to users may include hosting, supporting, and/or executing one or more instances of a virtual environment, determining view information defining and/or representing the virtual environment for the users, transmitting the view information to the client computing platforms associated with the users to facilitate one or more views of the virtual environment being presented to the users, and/or other activities.

The users may participate in the virtual space by controlling one or more elements in the virtual space. Control may be exercised through control inputs and/or commands input by the users through the client computing platforms. For example, one or more views of the virtual space may include a control icon configured to be controlled by a user. The control icon may be controlled by the user via a mouse, a keyboard, and/or other input devices associated with a client computing platform. In some implementations, control inputs and/or commands input by the users may include entering a selection of one or more elements in the virtual space. Entering a selection may include, for example, depressing a key or button on the mouse, keyboard, and/or other input devices associated with a client computing platform.

Within the instance(s) of the virtual space executed by the virtual space module, users may control user characters to interact with the virtual space and/or each other. As used herein, the term “user character” may refer to an entity present in the virtual space that represents an individual user. One or more views of the virtual space may include one or more entities. An entity may include an avatar representing the user. An entity and/or avatar representing a given user may be presented in views of the virtual space as being associated with content that may be provided by the given user, directed the given user, related to the given user, and/or associated with the given user in other ways. In some implementations, in views of the virtual space, entities and/or avatars may represent users as a game is being played and/or as other activities are performed by and/or among the users in the virtual space. Entities and/or avatars may include a combination of graphics, text, animations, video, and/or other design components that together serve the function to represent users within the virtual space. The entity and/or avatar representing a given user may be created and/or customized by the given user. The user may have an “inventory” of virtual goods and/or currency that the user can use display, gift, and/or otherwise interact with other users within the virtual space.

The user module may be configured to manage user profiles associated with individual users. The user profiles may include information related to users associated with the system. For example, the user profiles may comprise a first user profile that is associated with a first user. Managing user profiles associated with individual users may include managing storage of user profiles, managing access to user profiles, and/or other activities. A user profile may include information stored by the server, information stored by one or more of the client computing platforms, and/or information stored at other storage locations. A user profile may include information related to one or more of relationship information, virtual currency account information, a chat availability status, a private message availability status, an image of the user, demographic information, information identifying a user, subscription information, credit card information, usage information, settings, preferences, customizations, information related to past interactions with other users, achievements in the virtual space, information related to purchases, information derived by analysis, a client computing platform identification associated with a user, a phone number associated with a user, and/or other information.

The hover module may be configured to detect hovering on an entity in the virtual space. In some implementations, hovering on the one or more entities representing the users in the virtual space may be detected. The hover module may be configured such that hovering by a second user over an entity representing a first user can be detected. Hovering by the second user over the entity may be detected responsive to the second user controlling a control icon to point to the entity representing the first user in the view of the virtual space presented to the second user. The control icon and the view of the virtual space presented to the second user may be presented via a client computing platform associated with the second user. Hovering may comprise pointing to the entity representing the first user with the control icon without the second user further entering a selection of the first entity through client computing platform. In some implementations, hovering may be detected responsive to the second user controlling the control icon to continuously point to the entity representing the first user for a pre-determined amount of time. In some implementations, the pre-determined amount of time may be a minimum time threshold amount.

The interaction presentation module may be configured to facilitate presentation of an offered set of interaction identifiers associated with a user profile. The interaction presentation module may be configured to, responsive to detection of the second user hovering on the entity representing the first user, facilitate presentation of an offered set of interaction identifiers associated with a user profile associated with the first user. The offered set of interaction identifiers may be presented to the second user in the view of the virtual space presented to the second user via a client computing platform associated with the second user. In some implementations, the offered set of interaction identifiers may be presented substantially adjacent to the entity representing the first user in the view of the virtual space presented to the second user.

The offered set of interaction identifiers may include one or more of an interaction identifier related to sending a friend request, an interaction identifier related to sending a virtual gift, an interaction identifier related to allowing or preventing chat communication, an interaction identifier related to allowing or preventing private message communication, and/or other interaction identifiers.

The interaction identifiers may be configured to indicate a status associated with each interaction identifier. The status associated with each interaction identifier may be related to the user profile of a user represented by an entity, related to the user profile of the user controlling the control icon, related to previous entries and/or selections by the user controlling the control icon, and/or related to other factors.

In some implementations, the system may be configured such that a user may enter a selection of one or more of the interaction identifiers. A user may utilize the control icon and a client computing platform associated with the user to enter a selection of one or more of the interaction the identifiers in the view presented to the user.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to present information related to entities in a virtual space.

FIG. 2 illustrates a view of the virtual space that includes entities and a control icon.

FIG. 3 illustrates presentation of an offered set of interaction identifiers associated with a user profile.

FIG. 4 illustrates a method to present information related to entities in a virtual space.

### DETAILED DESCRIPTION

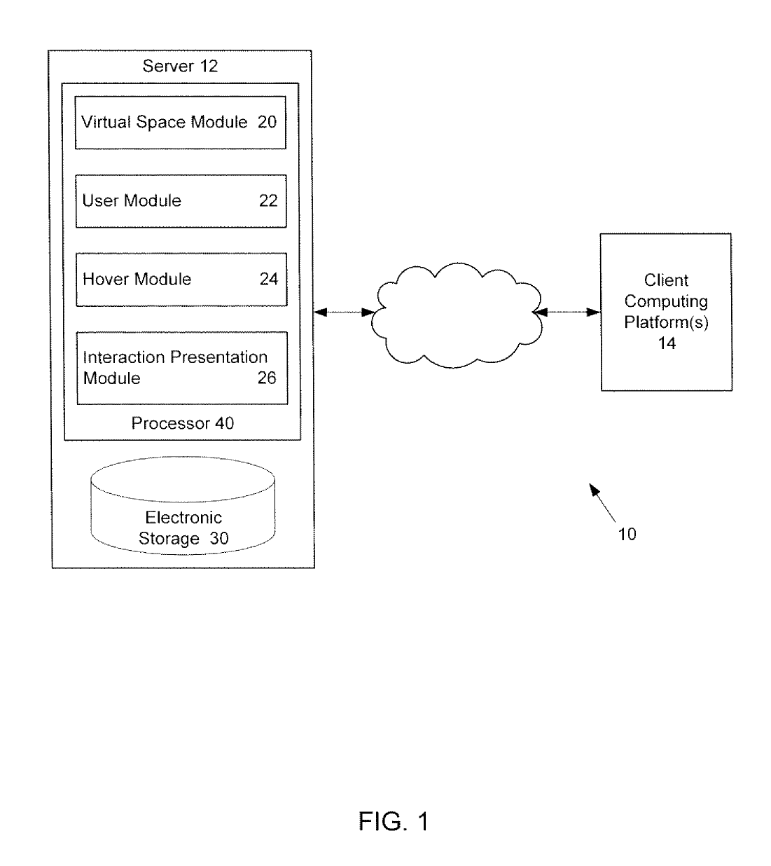

FIG. 1 illustrates a system 10 configured to present information related to entities in a virtual space. In some implementations, system 10 may include one or more servers 12, one or more client computing platforms 14, and/or other components. System 10 may be configured to provide a virtual space to users. System 10 may be configured such that the users participate in one or more games, activities, and/or applications within a virtual space and/or pertaining to a virtual space. By virtue of using system 10, users may have the ability to hover (e.g., via a control icon such a mouse pointer) over an entity in the virtual space that represents another user such that system 10 presents an offered set of interaction identifiers associated with the other user. This may enhance the online experience for participating users. Providing the virtual space may include hosting the virtual space over a network.

Server 12 may be configured to communicate with client computing platforms 14 according to client/server architecture. The users may access system 10, a virtual game space, and/or other virtual spaces via client computing platforms 14. As shown in FIG. 1, server 12 may be configured to execute one or more computer program modules. The computer program modules may include one or more of a virtual space module 20, a user module 22, a hover module 24, an interaction presentation module 26, and/or other modules.

Virtual space module 20 may be configured to provide one or more virtual spaces to users via client computing platforms 14. As used herein, a “virtual space” may include one or more interactive, electronic social media, and/or other virtual environments. A virtual space may refer to a virtual environment in which a game is being played that involves a plurality of users. Providing a virtual environment to users may include hosting, supporting, and/or executing one or more instances of a virtual environment, determining view information defining and/or representing the virtual environment (e.g., from one or more instances) for the users (e.g., individually and/or collectively), transmitting the view information to client computing platforms 14 associated with the users to facilitate one or more views of the virtual environment being presented to the users, and/or other activities.

Interactive, electronic social media may include one or more of a social network, a micro-blogging service, a blog service (or host), a browser-based game, a multi-player mobile game, a file (e.g., image file, video file, and/or other files) sharing service, a messaging service, a message board, a forum, and/or other electronically distributed media that are scalable and enable interaction between the users. Some non-limiting examples of interactive, electronic social media may include the micro-blogging service provided by Twitter™, the social network provided by Facebook™, the social network provided by MySpace™, the social network provided by Foursquare®, the virtual world provided by SecondLife®, the online poker game provided by Pokerist, the online game provided by World of Warcraft®, the file sharing service provided by Flickr®, Blogger, YouTube, PlayStation® Home, Xbox® Live, and/or other interactive electronic social media.

A virtual space may comprise a simulated space that is accessible by users via clients (e.g., client computing platforms 14) that present the views of the virtual space to a user. The simulated space may have a simulated physical layout, express ongoing real-time interaction by one or more users, and/or be constrained by simulated physics that govern interactions between virtual objects in the simulated space. In some instances, the simulated physical layout may be a 2-dimensional layout. In other instances, the simulated physical layout may be a 3-dimensional layout.

The users may participate in the virtual space by controlling one or more elements in the virtual space (e.g., game elements such as playing cards, and/or other elements). Control may be exercised through control inputs and/or commands input by the users through client computing platforms 14. For example, one or more views of the virtual space may include a control icon (e.g., a mouse pointer) configured to be controlled by a user. The control icon may be controlled by the user via a mouse, a keyboard, and/or other input devices associated with a client computing platform 14. In some implementations, control inputs and/or commands input by the users may include entering a selection of one or more elements in the virtual space. Entering a selection may include, for example, depressing a key or button on the mouse, keyboard, and/or other input devices associated with a client computing platform 14.

Within the instance(s) of the virtual space executed by virtual space module 20, users may control user characters to interact with the virtual space and/or each other (e.g., with the control icon). As used herein, the term “user character” may refer to an entity (or group of entities) present in the virtual space that represents an individual user. One or more views of the virtual space may include one or more entities. An entity may include an avatar representing the user. An entity and/or avatar representing a given user may be presented in views of the virtual space as being associated with content that may be provided by the given user, directed the given user, related to the given user, and/or associated with the given user in other ways. In some implementations, in views of the virtual space, entities and/or avatars may represent users as a game is being played and/or as other activities are performed by and/or among the users in the virtual space. Entities and/or avatars may include a combination of graphics, text, animations, video, and/or other design components that together serve the function to represent users within the virtual space. The entity and/or avatar representing a given user may be created and/or customized by the given user. The user may have an “inventory” of virtual goods and/or currency that the user can use (e.g., by manipulation of an avatar or other user controlled element, and/or other items), display, gift, and/or otherwise interact with other users within the virtual space.

Virtual space module 20 may be configured to express the virtual space in a relatively limited manner. For example, views of the virtual space presented to the users may be selected from a limited set of graphics depicting an event in a given place within the virtual space. The views may include additional content (e.g., text, audio, pre-stored video content, movable icons, avatars, and/or other content) that describes particulars of the current state of the virtual space, beyond the relatively generic graphics. For example, a view of the virtual space may depict a card table and/or a non-player character that are static (or change relatively little) visually in views of the virtual space. Icons representing game components (e.g., game pieces, playing cards, dice, and/or other game components) may change and/or move within the views of the virtual space to depict a game being played within the virtual space. Such limited representation of the virtual space may reduce the cost of hosting the virtual space in terms of processing, storage, communication bandwidth, and/or other computing resource (e.g., on server 12 and/or client computing platforms 14). Other expressions of individual places within the virtual space are contemplated.

It will be appreciated that the description herein of virtual space module 20 providing a virtual space to a set of users in which a game is being played by the set of users is not intended to be limiting. For example, virtual space module 20 may be configured to provide a plurality of different virtual spaces to a plurality of different sets of users. The individual sets of users may be participating in different instances of a game within the individual virtual spaces. The concepts described herein with respect to the individual virtual space and game should be extendible to implementations in which a plurality of different virtual spaces are being used to conduct a plurality of different instances of the game (e.g., between different sets of users).

User module 22 may be configured to manage user profiles associated with individual users. The user profiles may include information related to users associated with the system. For example, the user profiles may comprise a first user profile that is associated with a first user. Managing user profiles associated with individual users may include managing storage of user profiles, managing access to user profiles, and/or other activities. A user profile may include information stored by server 12, information stored by one or more client computing platforms 14, and/or information stored at other storage locations. A user profile may include information related to one or more of relationship information (e.g., information related to relationships between users in the virtual space), virtual currency account information (e.g., related to currency held in credit for a user), a chat availability status, a private message availability status, an image of the user, demographic information (e.g., the language spoken by the user), information identifying a user (e.g. a username or handle, a number, an identifier, and/or other identifying information), subscription information, credit card information, usage information, settings, preferences, customizations, information related to past interactions with other users, achievements in the virtual space, information related to purchases, information derived by analysis, a client computing platform identification associated with a user, a phone number associated with a user, and/or other information.

Hover module 24 may be configured to detect hovering on an entity in the virtual space. In some implementations, hovering on the one or more entities representing the users in the virtual space may be detected. Hover module 24 may be configured such that hovering by a second user over an entity representing a first user can be detected. Hovering by the second user over the entity may be detected responsive to the second user controlling a control icon to point to the entity representing the first user in the view of the virtual space presented to the second user. The control icon and the view of the virtual space presented to the second user may be presented via a client computing platform 14 associated with the second user. Hovering may comprise pointing to the entity representing the first user with the control icon without the second user further entering a selection of the first entity through client computing platform 14.

In some implementations, hovering may be detected responsive to the second user controlling the control icon to continuously point to the entity representing the first user for a pre-determined amount of time. In some implementations, the pre-determined amount of time may be a minimum time threshold amount. Hovering may be detected responsive to the second user controlling the control icon to point to an entity representing the first user for an amount of time that meets and/or exceeds the minimum time threshold amount. The pre-determined amount of time and/or the minimum time threshold amount may be set by an administrator of the space and/or a space server, determined by hover module 24 based on information entered by a user to a client computing platform 14, determined by hover module 24 based on previous virtual space interaction by a user, and/or determined by other methods.

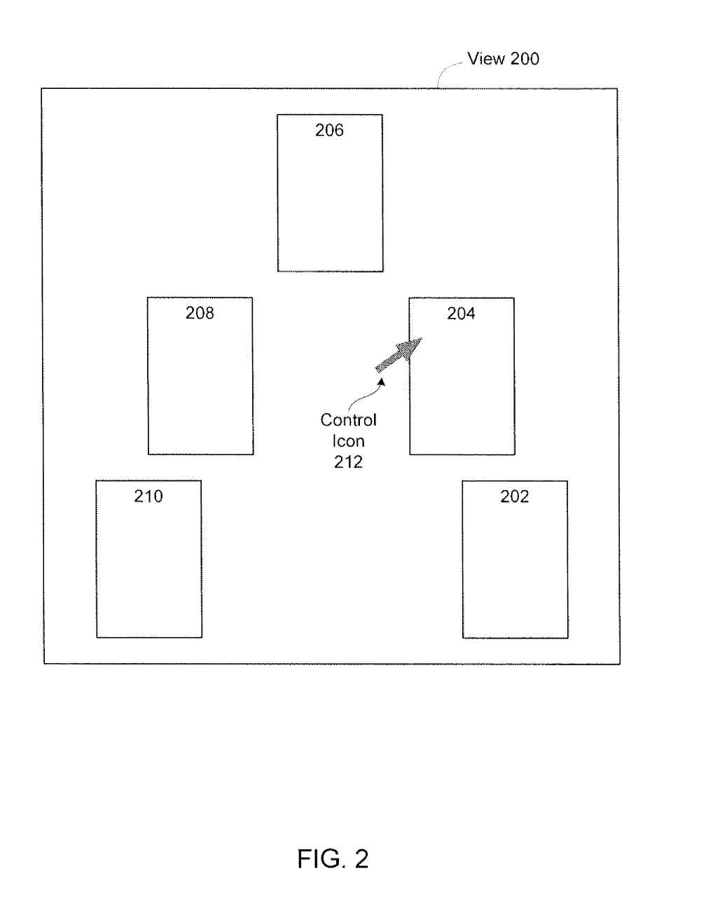

By way of a non-limiting example, FIG. 2 illustrates a view 200 of the virtual space that includes entities 202, 204, 206, 208, 210, and a control icon 212. Entities 202, 204, 206, 208, and/or 210 may comprise avatars representing different users. In some implementations, view 200 may be presented to a user represented by one of entities 202, 204, 206, 208, and/or 210. In some implementations, view 200 may be presented to a user not represented by one of entities 202, 204, 206, 208, and/or 210. View 200 may be presented to a user (e.g., the second user described above) on a client computing platform associated with the user. The user viewing view 200 may control icon 212 to point to one of entities 202, 204, 206, 208, or 210. In FIG. 2, the user is controlling icon 212 to point to entity 204. Hovering on entity 204 may be detected responsive to the user controlling icon 212 to continuously point to entity 204 for an amount of time that meets and/or exceeds the minimum time threshold amount (without the user further entering a selection of entity 204 through the client computing platform).

Returning to FIG. 1, interaction presentation module 26 may be configured to facilitate presentation of an offered set of interaction identifiers associated with a user profile. The interaction presentation module may be configured to, responsive to detection of the second user hovering on the entity representing the first user, facilitate presentation of an offered set of interaction identifiers associated with a user profile associated with the first user. The offered set of interaction identifiers may be presented to the second user in the view of the virtual space presented to the second user via a client computing platform 14 associated with the second user. In some implementations, the offered set of interaction identifiers may be presented substantially adjacent to the entity representing the first user in the view of the virtual space presented to the second user.

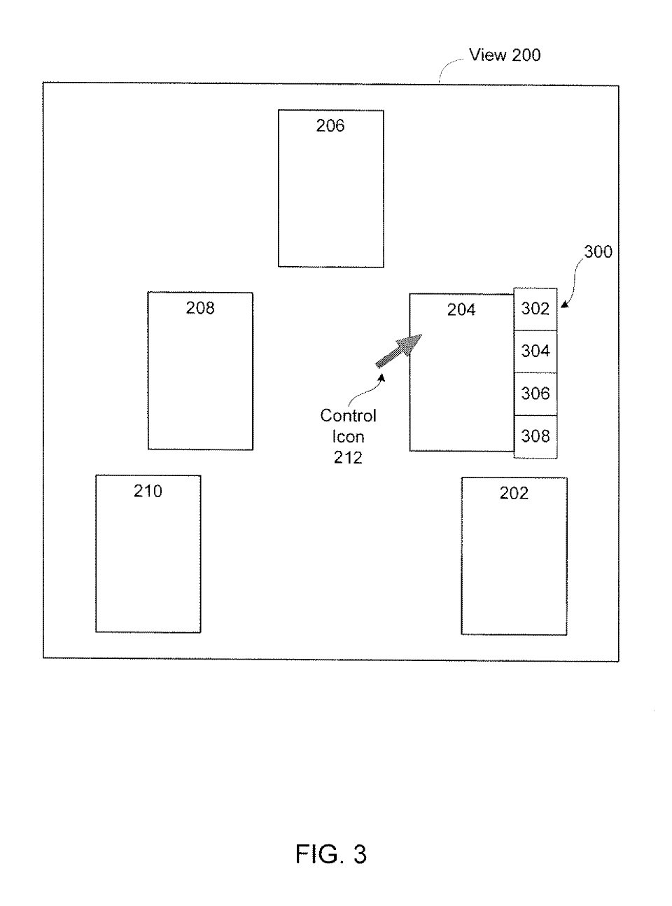

By way of a non-limiting example, FIG. 3 illustrates presentation of an offered set of interaction identifiers 300 associated with a user profile of a user represented by entity 204. As described above with respect to FIG. 2, view 200 may be presented to a user (e.g., the second user) on a client computing platform associated with the user. The user viewing view 200 may control icon 212 to point to entity 204. Hovering on entity 204 may be detected (e.g., by hover module 24 described above) responsive to the user controlling icon 212 to continuously point to entity 204 for an amount of time that meets and/or exceeds the minimum time threshold amount (without the user further entering a selection of entity 204 through the client computing platform). Responsive to hovering on entity 204 being detected, offered set of interaction identifiers 300 associated with the user profile of the user represented by entity 204 (e.g., the first user) may be presented. Offered set of interaction identifiers 300 may be presented in view 200 substantially adjacent to entity 204.

Offered set of interaction identifiers 300 may include one or more of an interaction identifier 302 related to sending a friend request, an interaction identifier 304 related to sending a virtual gift, an interaction identifier 306 related to allowing or preventing chat communication, an interaction identifier 308 related to allowing or preventing private message communication, and/or other interaction identifiers.

Interaction identifier 302 may be related to allowing a user (e.g., the second user) to send a friend request to the user represented by entity 204 (e.g., the first user). A friend request may comprise an invitation to the user represented by entity 204 to establish a relationship between the two users in the virtual space.

Interaction identifier 304 may be related to allowing a user (e.g., the second user) to send a virtual gift to the user represented by entity 204 (e.g., the first user). A virtual gift may comprise virtual content in the virtual space. The content may be virtually tangible (e.g., virtual poker chips for a poker game in the virtual space) and/or not virtually tangible (e.g., access to a level of game play in the virtual space). In some implementations, system 10 may be configured such that interaction identifier 304 may be related to allowing system 10 to receive and/or process payments from a user for a purchase of virtual gifts for the user represented by entity 204.

Interaction identifier 306 may be related to allowing a user (e.g., the second user) to allow or prevent chat communication from the user represented by entity 204 (e.g., the first user). Users may be able to communicate, or “chat”, with each other while participating in the virtual space. In some implementations, system 10 may be configured such that the user represented by entity 204 may be able to allow and/or prevent chat communication from other users.

Interaction identifier 308 may be related to allowing a user (e.g., the second user) to allow or prevent private message communication from the user represented by entity 204 (e.g., the first user). Users may be able to communicate with each other via private messages (e.g., email) while participating in the virtual space. In some implementations, system 10 may be configured such that the user represented by entity 204 may be able to allow and/or prevent private message communication from other users.

Interaction identifiers 302, 304, 306, 308, and/or other interaction identifiers may be configured to indicate a status associated with each interaction identifier. In FIG. 3, the status associated with each interaction identifier may be related to the user profile of the user represented by entity 204, related to the user profile of the user controlling icon 212, related to previous entries and/or selections by the user controlling icon 212, and/or related to other factors. For example, interaction identifier 302 may indicate a relationship status indicating that the user controlling icon 212 and the user represented by entity 204 are already friends. Interaction identifier 304 may indicate a gift status indicating whether the user controlling icon 212 has already given one or more gifts to the user represented by entity 204. Interaction identifier 306 may indicate a chat status indicating whether the user controlling icon 212 has previously blocked and/or allowed chat communication from the user represented by entity 204, and/or whether the user represented by entity 204 has previously blocked and/or allowed chat communication from other users. Interaction identifier 308 may indicate a private message status indicating whether the user controlling icon 212 has previously blocked and/or allowed private message communication from the user represented by entity 204, and/or whether the user represented by entity 204 has previously blocked and/or allowed private message communication from other users.

In some implementations, system 10 may be configured such that a user may enter a selection of one or more of interaction identifiers 302, 304, 306, 308, and/or other interaction identifiers. A user may utilize control icon 212 and a client computing platform associated with the user to enter a selection of one or more of interaction identifiers 302, 304, 306, 308, and/or other interaction identifiers in view 200 presented to the user.

The quantity and placement of interaction identifiers 300 in FIG. 3 is not intended to be limiting. The present disclosure contemplates any number of interaction identifiers positioned at any one or more other locations in view 200 and/or in one or more other views of the virtual space.

Returning to FIG. 1, in some implementations, server 12 and client computing platforms 14 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server 12 and/or client computing platforms 14 may be connected and/or interface via some other configuration and/or mechanism.

A given client computing platform 14 may include one or more processors, an electronic display, a control interface, and/or other components. The one or more processors may be configured to execute computer program modules. The computer program modules may be configured to enable a user associated with the given client computing platform 14 to interface with system 10, and/or provide other functionality attributed herein to client computing platforms 14. For example, the computer program modules may include a module configured to receive view information from server 12 (e.g., generated by virtual space module 20), and to present a view of the virtual space (as described above) based on the received view information. This may facilitate participation by the user of the given client computing platform 14 in a game (for example) taking place in the virtual space. By way of non-limiting example, the given client computing platform 14 may include one or more of a desktop computer, a laptop computer, a handheld computer, a tablet computing platform, a NetBook, a Smartphone, a gaming console, and/or other computing platforms and/or devices.

Server 12 may include electronic storage 30, one or more processors 40, and/or other components. Server 12 may include communication lines, or ports to enable the exchange of information with a network and/or other computing platforms. Illustration of server 12 in FIG. 1 is not intended to be limiting. Server 12 may include a plurality of hardware, software, and/or firmware components operating together to provide the functionality attributed herein to server 12. For example, server 12 may be implemented by a cloud of computing platforms operating together as server 12.

Electronic storage 30 may comprise electronic storage media that electronically stores information. The electronic storage media of electronic storage 30 may include one or both of system storage that is provided integrally (i.e., substantially non-removable) with server 12 and/or removable storage that is removably connectable to server 12 via, for example, a port (e.g., a USB port, a firewire port, etc.) or a drive (e.g., a disk drive, etc.). Electronic storage 30 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 30 may include one or more virtual storage resources (e.g., cloud storage, a virtual private network, and/or other virtual storage resources). Electronic storage 30 may store software algorithms, information determined by processor 40, information received from server 12, information received from client computing platforms 14, and/or other information that enables server 12 to function as described herein.

Processor 40 may be configured to provide information processing capabilities in server 12. As such, processor 40 may include one or more of a digital processor, an analog processor, a digital circuit designed to process information, an analog circuit designed to process information, a state machine, and/or other mechanisms for electronically processing information. Although processor 40 is shown in FIG. 1 as a single entity, this is for illustrative purposes only. In some implementations, processor 40 includes a plurality of processing units. These processing units may be physically located within the same device, or processor 40 may represent processing functionality of a plurality of devices operating in coordination. Processor 40 may be configured to execute modules 20, 22, 24, and/or 26 by software; hardware; firmware; some combination of software, hardware, and/or firmware; and/or other mechanisms for configuring processing capabilities on processor 40.

It should be appreciated that although modules 20, 22, 24, and 26 are illustrated in FIG. 1 as being co-located within a single processing unit, in implementations in which processor 40 includes multiple processing units, one or more of modules 20, 22, 24, and/or 26 may be located remotely from the other modules. The description of the functionality provided by the different modules 20, 22, 24, and/or 26 described herein is for illustrative purposes, and is not intended to be limiting, as any of modules 20, 22, 24, and/or 26 may provide more or less functionality than is described. For example, one or more of modules 20, 22, 24, and/or 26 may be eliminated, and some or all of its functionality may be provided by other ones of modules 20, 22, 24, and/or 26. As another example, processor 40 may be configured to execute one or more additional modules that may perform some or all of the functionality attributed below to one of modules 20, 22, 24, and/or 26.

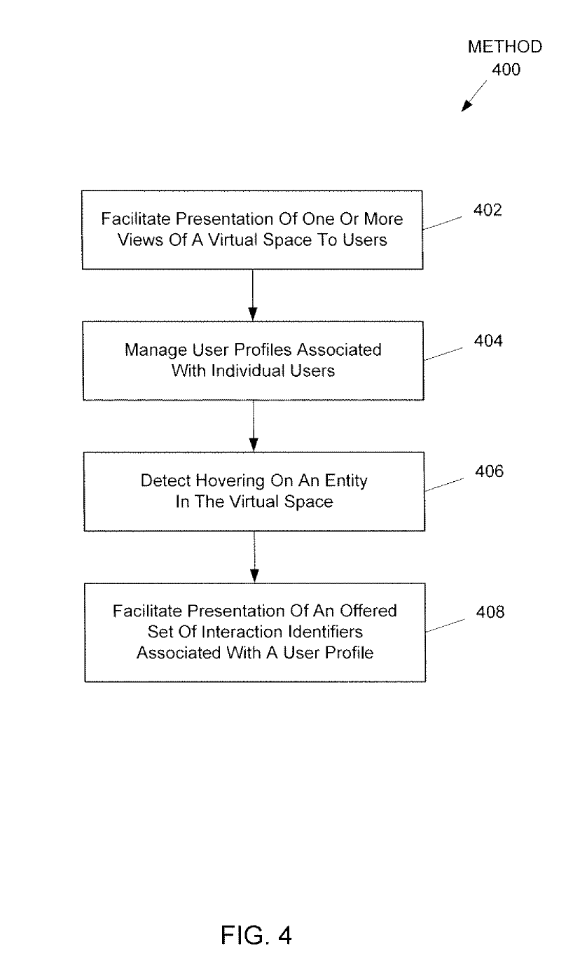

FIG. 4 illustrates a method 400 to present information related to entities in a virtual space. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, presentation of one or more views of a virtual space to users on one or more client computing platforms associated with the users may be facilitated. The one or more views of the virtual space may include a control icon configured to be controlled by the users. The virtual space may include one or more entities representing the users. The users may include a first user and a second user. The first user may be represented by a first entity. The second user may control a first control icon in a view of the virtual space presented to the second user via a first client computing platform. In some implementations, operation 402 may be performed by a virtual space module similar to, and/or the same as virtual space module 20 (shown in FIG. 1, and described herein).

At an operation 404, user profiles associated with individual users may be managed. The user profiles may include information related to users associated with the system. The user profiles may comprise a first user profile that is associated with the first user. In some implementations, operation 404 may be performed by a user module similar to, and/or the same as user module 22 (shown in FIG. 1 and described herein).

At an operation 406, hovering on an entity in the virtual space may be detected. Hovering by the second user over the first entity may be detected responsive to the second user controlling the first control icon to point to the first entity. The second user may control the first control icon in the view of the virtual space presented to the second user via the first client computing platform. The second user may control the first control icon to point to the first entity without the second user further entering a selection of the first entity through the first client computing platform. In some implementations, operation 406 may be performed by a hover module similar to, and/or the same as hover module 24 (shown in FIG. 1 and described herein).

At an operation 408, presentation of an offered set of interaction identifiers associated with a user profile may be facilitated. Responsive to detection of the second user hovering on the first entity, an offered set of interaction identifiers associated with the first user profile may be presented to the second user in the view of the virtual space presented to the second user via the first client computing platform. In some implementations, operation 408 may be performed by an interaction presentation module similar to, and/or the same as interaction presentation module 26 (shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system configured to present information related to entities in a virtual space, the system comprising:
one or more processors configured to execute computer program modules, the computer program modules comprising:
a virtual space module configured to facilitate presentation of one or more views of the virtual space to users on one or more client computing platforms associated with the users, the one or more views of the virtual space including a control icon configured to be controlled by the users, the virtual space including one or more entities representing the users, the users including a first user and a second user, wherein the first user is represented by a first entity, and wherein the second user controls a first control icon in a view of the virtual space presented to the second user via a first client computing platform;
a user module configured to manage user profiles associated with individual users, the user profiles including information related to users associated with the system, the user profiles comprising a first user profile that is associated with the first user;
a hover module configured to detect hovering on an entity in the virtual space, the hover module being configured such that hovering by the second user over the first entity is detected responsive to the second user controlling the first control icon to point to the first entity in the view of the virtual space presented to the second user via the first client computing platform without the second user further entering a selection of the first entity through the first client computing platform; and
an interaction presentation module configured to facilitate presentation of an offered set of interaction identifiers associated with a user profile, wherein the interaction presentation module is configured to, responsive to detection of the second user hovering on the first entity, facilitate presentation of an offered set of interaction identifiers associated with the first user profile to the second user in the view of the virtual space presented to the second user via the first client computing platform.

2. The system of claim 1, wherein a user profile includes information related to one or more of the user's friends in the virtual space, virtual currency held by the user in the virtual space, a chat availability status, a private message availability status, an image of the user, or the language spoken by the user.

3. The system of claim 2, wherein the virtual currency includes poker chips.

4. The system of claim 1, wherein the offered set of interaction identifiers includes an interaction identifier related to sending a friend request.

5. The system of claim 1, wherein the offered set of interaction identifiers includes an interaction identifier related to sending a virtual gift.

6. The system of claim 1, wherein the offered set of interaction identifiers includes an interaction identifier related to allowing or preventing chat communication.

7. The system of claim 1, wherein the offered set of interaction identifiers includes an interaction identifier related to allowing or preventing private message communication.

8. The system of claim 1, wherein the one or more entities representing the users include one or more avatars.

9. The system of claim 1, wherein the offered set of interaction identifiers is presented substantially adjacent to the entity in the view of the virtual space presented to the second user via the first client computing platform.

10. A method to present information related to entities in a virtual space, the method comprising:
facilitating presentation of one or more views of the virtual space to users on one or more client computing platforms associated with the users, the one or more views of the virtual space including a control icon configured to be controlled by the users, the virtual space including one or more entities representing the users, the users including a first user and a second user, wherein the first user is represented by a first entity, and wherein the second user controls a first control icon in a view of the virtual space presented to the second user via a first client computing platform;
managing user profiles associated with individual users, the user profiles including information related to users associated with the system, the user profiles comprising a first user profile that is associated with the first user;
detecting hovering on an entity in the virtual space, wherein hovering by the second user over the first entity is detected responsive to the second user controlling the first control icon to point to the first entity in the view of the virtual space presented to the second user via the first client computing platform without the second user further entering a selection of the first entity through the first client computing platform; and
facilitating presentation of an offered set of interaction identifiers associated with a user profile, wherein, responsive to detection of the second user hovering on the first entity, an offered set of interaction identifiers associated with the first user profile is presented to the second user in the view of the virtual space presented to the second user via the first client computing platform.

11. The method of claim 10, wherein a user profile includes information related to one or more of the user's friends in the virtual space, virtual currency held by the user in the virtual space, a chat availability status, a private message availability status, an image of the user, or the language spoken by the user.

12. The method of claim 11, wherein the virtual currency includes poker chips.

13. The method of claim 10, wherein the offered set of interaction identifiers includes an interaction identifier related to sending a friend request.

14. The method of claim 10, wherein the offered set of interaction identifiers includes an interaction identifier related to sending a virtual gift.

15. The method of claim 10, wherein the offered set of interaction identifiers includes an interaction identifier related to allowing or preventing chat communication.

16. The method of claim 10, wherein the offered set of interaction identifiers includes an interaction identifier related to allowing or preventing private message communication.

17. The method of claim 10, wherein the one or more entities representing the users include one or more avatars.

18. The method of claim 10, wherein the offered set of interaction identifiers is presented substantially adjacent to the entity in the view of the virtual space presented to the second user via the first client computing platform.
